(19) United States
(12) Patent Application Publication
(10) Pub. No.: US 2012/0141838 A1
(43) Pub. Date: Jun. 7, 2012

(54) WATERPROOF BATTERY

(75) Inventors: HOYUAN LIN, Tucheng City (TW); CHING-FENG HSIEH, Taipei City (TW)

(73) Assignee: ASKEY COMPUTER CORP., TAIPEI (TW)

(21) Appl. No.: 12/980,711

(22) Filed: Dec. 29, 2010

(30) Foreign Application Priority Data
Dec. 3, 2010 (TW) 099142118

(51) Int. Cl. H01M 10/42

(52) U.S. Cl. 429/7

(57) ABSTRACT

A waterproof battery includes a casing having an opening; a battery body received in the casing; a connecting unit disposed in the casing, wherein the connecting unit has a circuit board electrically connected to the battery body and a connector electrically connected to the circuit board and protruded from the opening; and a waterproof adhesive layer for being affixed to and thereby connecting an inner surface of the casing and a bottom side of the circuit board so as to hermetically seal the opening. Accordingly, the waterproof battery is capable of preventing water or liquid from intruding into the battery body to cause damage thereto, that is, a built-in capacity to be water-free.

### CROSS-REFERENCE TO RELATED APPLICATION

This non-provisional application claims priority under 35 U.S.C. §119(a) on Patent Application No(s).099142118 filed in Taiwan, R.O.C. on Dec. 3, 2010, the entire contents of which are hereby incorporated by reference.

### FIELD OF THE TECHNOLOGY

The present invention relates to waterproof batteries, and more particularly, to a waterproof battery for use with a mobile electronic device and capable of preventing water or liquid from intruding into a battery body through a joint therein.

### BACKGROUND

A wide variety of portable electronic devices are indispensable to people nowadays in daily life. Due to their advancement and prevalence, the portable electronic devices have increasingly strict waterproof requirements. Waterproof portable electronic products, such as mobile phones, PDA, multimedia players, digital cameras, and electronic watches, abound in the market. A waterproof portable electronic product is usually rendered waterproof by means of its casing. However, the batteries disposed in the portable electronic products are not waterproof and thus may admit water, thereby ending up with damaged parts and components or short-circuited contacts of the batteries. The deterioration in electrical characteristics of the water-stricken batteries remains unabated even after the invading water has evaporated. Sophisticated, precise electronic products, such as notebook computers, are equipped mostly with a casing that is not waterproof; hence, they are vulnerable to a splash or a dip which might damage the computer or cause a battery to break down, or even cause the battery to burn out, thereby posing a threat to personal safety.

Referring to FIG. 1, there is shown a schematic view of connection between a casing 110 and a connecting unit 120 of a conventional battery 1. As shown in the drawing, the battery 1 comprises the casing 110, the connecting unit 120, a flexible flat cable (FFC) 150, and a battery body 160. The casing 110 comprises an upper portion and a lower portion. The upper and lower portions of the casing 110 together define a receiving space therein for receiving the connecting unit 120, the FFC 150, and the battery body 160. The connecting unit 120 comprises a connector 130 and a printed circuit board 140. The connector 130 is electrically connected to the printed circuit board 140, protruded from an opening 111 of the casing 110, and configured to supply power to an electronic product connected with the connector 130. The printed circuit board 140 is electrically connected to the battery body 160 via the FFC 150. The upper and lower portions of the casing 110 are joined by means of ultrasonic lamination, such that the casing 110 is waterproof to a great extent. However, the opening 111 of the casing 110 is not in seamless contact with the connecting unit 120 protruding from the opening 111; instead, there is a small gap there between. As a result, water may intrude into the battery body 160 through the gap, thereby ending up with damaged or burnt said battery 1.

Accordingly, it is imperative to provide a waterproof battery for use with a mobile electronic device and capable of preventing water or liquid from intruding into the waterproof battery.

### SUMMARY

It is an objective of the present invention to provide a waterproof battery for preventing water or liquid from intruding into the waterproof battery through a joint between an opening of a casing and a connecting unit of the waterproof battery such that the waterproof battery is rendered waterproof independently.

In order to achieve the above and other objectives, the present invention provides a waterproof battery. The waterproof battery comprises: a casing having an opening; a battery body received in the casing; a connecting unit disposed in the casing, wherein the connecting unit has a circuit board electrically connected to the battery body and a connector electrically connected to the circuit board and protruded from the opening; and a waterproof adhesive layer for being affixed to and thereby connecting an inner surface of the casing and a bottom side of the circuit board so as to hermetically seal the opening.

The waterproof battery further comprises an insulating pad disposed on another side of the waterproof adhesive layer and a transmitting element for electrically connecting the circuit board and the battery body. The waterproof adhesive layer is affixed to and thereby connects the inner surface of the casing, the bottom side of the circuit board, and the insulating pad so as to completely close the opening. The insulating pad has therein a through hole whereby the transmitting element is electrically connected to the circuit board. The transmitting element is a flexible flat cable (FFC) or a flexible printed circuit (FPC).

The waterproof adhesive layer of the waterproof battery adheres to an opening-adjoining portion of the inner surface of the casing and a peripheral portion of the circuit board concurrently, so as to seal the gap lying circumferentially between the connecting unit and the casing.

As regards the waterproof battery, a recess portion is disposed on a sidewall of the opening of the casing for receiving the circuit board of the connecting unit.

The connector of the waterproof battery is a surface-mounted connector based on surface mount technology (SMT).

Accordingly, the waterproof battery of the present invention prevents water or liquid from intruding into the waterproof battery and causing damage thereto.

### BRIEF DESCRIPTION OF THE DRAWINGS

To enable persons skilled in the art to fully understand the objectives, features, and advantages of the present invention, the present invention is hereunder illustrated with specific embodiments in conjunction with the accompanying drawings, in which:

FIG. 1 (PRIOR ART) is a schematic view of connection between a casing and a connecting unit of a conventional battery;

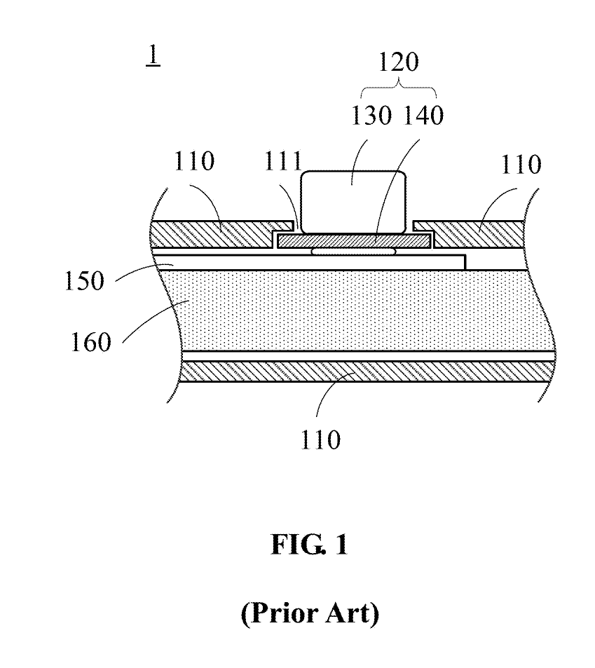

FIG. 2 is a schematic view of a waterproof battery according to a first embodiment of the present invention; and

FIG. 3 is a schematic view of a waterproof battery according to a second embodiment of the present invention.

### DETAILED DESCRIPTION

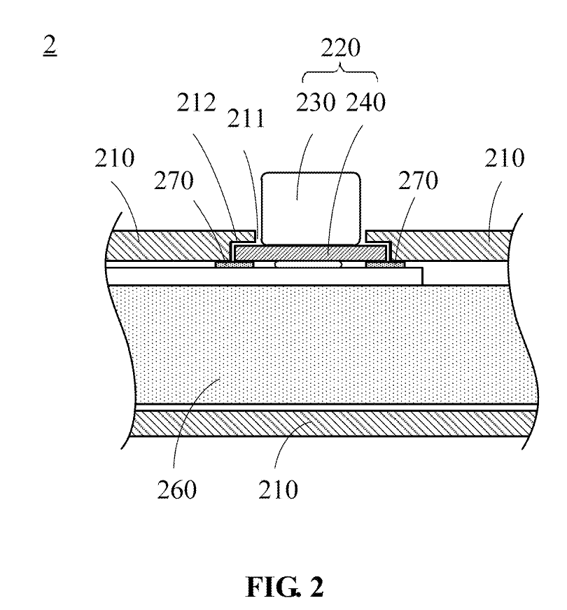

Referring to FIG. 2, there is shown a schematic view of a waterproof battery 2 according to a first embodiment of the present invention. As shown in the drawing, the waterproof battery 2 comprises a casing 210, a connecting unit 220, a waterproof adhesive layer 270, and a battery body 260. The casing 210 has an opening 211. The battery body 260 is received in the casing 210. The connecting unit 220 is disposed in the casing 210. The connecting unit 220 comprises a connector 230 and a circuit board 240. The connector 230 is electrically connected to the circuit board 240 and protruded from the opening 211. The circuit board 240 is electrically connected to the battery body 260. The connector 230 electrically connects the battery body 260 and an electronic device, and conveys power generated by the battery body 260 to the electronic device via the connecting unit 220. The waterproof adhesive layer 270 is affixed to and thereby connects the inner surface of the casing 210 and the bottom side of the circuit board 240. To be specific, one side of the waterproof adhesive layer 270 adheres to an opening-adjoining portion of the inner surface of the casing 210 and a peripheral portion of the circuit board 240 of the connecting unit 220 concurrently, so as to seal the gap lying circumferentially between the connecting unit 220 and the casing 210. Since the gap between the connecting unit 220 and the casing 210 is hermetically sealed by the waterproof adhesive layer 270, the opening 211 is completely closed, isolated from the outside of the waterproof battery 2, and thus protected against intrusion of water or liquid into the casing 210.

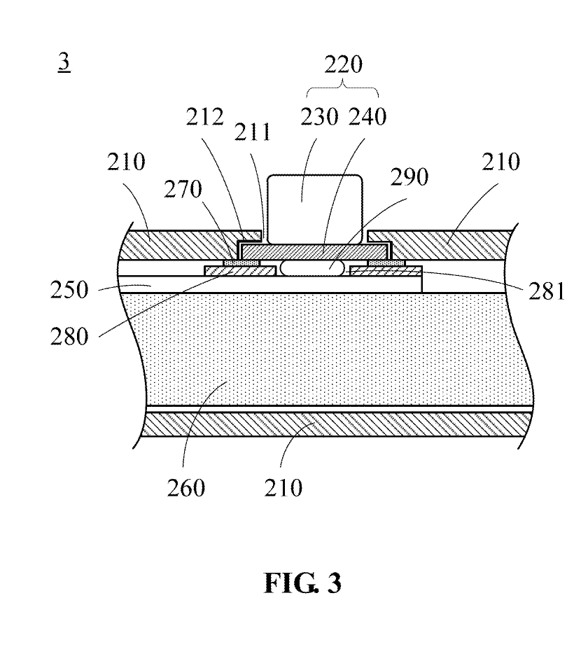

Referring to FIG. 3, there is shown a schematic view of a waterproof battery 3 according to a second embodiment of the present invention. As shown in the drawing, the waterproof battery 3 is based on the waterproof battery 2 in the first embodiment and further comprises an insulating pad 280 disposed on the other side of the waterproof adhesive layer 270 and a transmitting element 250 for electrically connecting the circuit board 240 and the battery body 260. The insulating pad 280 provides a plane for supporting the waterproof adhesive layer 270 and assisting the waterproof adhesive layer 270 in being affixed to and thereby connecting the inner surface of the casing 210, the bottom side of the circuit board 240, and the insulating pad 280 so as to completely close the opening 211; hence, the insulating pad 280 firmly fixes the connecting unit 220 to the opening 211 of the casing 210. The transmitting element 250 is disposed beneath the insulating pad 280 and configured to electrically connect the circuit board 240 of the connecting unit 220 and the battery body 260. Due to the transmitting element 250, the circuit board 240 and the connector 230, the power from the battery body 260 can be supplied to an electronic device. The insulating pad 280 has therein a through hole 281. The through hole 281 is the hollow core of the insulating pad 280. Alternatively, the through hole 281 corresponds in shape to the gap lying circumferentially between the casing 210 and the connecting unit 220. It is feasible to electrically connect the transmitting element 250 and the circuit board 240, by performing a connection operation, such as soldering, wiring, or any other form of electrical connection, on the through hole 281 and any gap defined with the waterproof adhesive layer 270. In this embodiment, the aforesaid electrical connection can be implemented, for example, by filling the through hole 281 and any gap defined with the waterproof adhesive layer 270 with a solder 290.

The transmitting element 250 of the waterproof battery 3 in the second embodiment of the present invention has an electrical transmission interface and is exemplified by a flexible flat cable (FFC) or a flexible printed circuit (FPC). The two ends of the transmitting element 250 are electrically connected to the circuit board 240 of the connecting unit 220 and the battery body 260.

The thickness of the insulating pad 280 of the waterproof battery 3 in the second embodiment of the present invention depends on gaps between the casing 210 and components therein, and is preferably 0.1-0.4 mm The insulating pad 280 is made of a material including, but not limited thereto, plastics, silica gel, mylar, polycarbonate resin (PC), or polyvinyl chloride (PVC), and thus is thin and capable of insulation.

As regards the waterproof batteries 2, 3 of the present invention, a recess portion 212 is disposed on the sidewall of the opening 211 of the casing 210 for receiving the circuit board 240 of the connecting unit 220. Hence, the edge of the circuit board 240 is engaged with and fixed to the recess portion 212 to thereby enable the connector 230 to protrude from the opening 211 of the casing 210 and prevent the connecting unit 220 from disconnecting with the casing 210.

The connector 230 is a battery-powered electronic connector, or preferably a surface-mounted connector based on surface mount technology (SMT). Advantageously, the connector 230 is downsized and miniaturized, and is of high contact density. An electrical contact of the connector 230 is electrically connected to the circuit board 240 by soldering, using tin or tin alloy, such that power generated by the battery body 260 is supplied to an electronic device.

The waterproof adhesive layer 270 is insulative, waterproof, and adhesive. The waterproof adhesive layer 270 is made of an adhesive of high viscosity (low fluidity), such as polymer resin, acrylic plastic, or epoxy resin, or made of a self-adhesive tape, such as industrial tape and twin adhesive tape. The amount of glue administered, dimensions, or thickness of the waterproof adhesive layer 270 depend on the dimensions of the casing 210, the connecting unit 220, and the gap therebetween.

The waterproof batteries 2, 3 of the present invention has an advantage, which is an improvement on the prior art indeed, namely preventing water or liquid intrusion into a battery to thereby protect electronic components therein, electrical connection of a transmission interface for the battery, or electrical connection between series-connected battery bodies of the battery.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments without departing from the spirit embodied in the disclosure of the present invention should fall within the scope of the present invention as set forth in the appended claims. Accordingly, the protection for the present invention should be defined by the appended claims.

What is claimed is:

1. A waterproof battery, comprising:
a casing having an opening;
a battery body received in the casing;
a connecting unit disposed in the casing, wherein the connecting unit has a circuit board electrically connected to the battery body and a connector electrically connected to the circuit board and protruded from the opening; and
a waterproof adhesive layer for being affixed to and thereby connecting an inner surface of the casing and a bottom side of the circuit board so as to hermetically seal the opening.

2. The waterproof battery of claim 1, wherein the waterproof adhesive layer adheres to an opening-adjoining portion of the inner surface of the casing and a peripheral portion of the circuit board concurrently.

3. The waterproof battery of claim 1, wherein a recess portion is disposed on a sidewall of the opening of the casing for receiving the circuit board of the connecting unit.

4. The waterproof battery of claim 1, wherein the connector is a surface-mounted connector.

5. The waterproof battery of claim 1, wherein further comprises an insulating pad disposed on another side of the waterproof adhesive layer and a transmitting element for electrically connecting the circuit board and the battery body, the waterproof adhesive layer being affixed to and thereby connecting the inner surface of the casing, the bottom side of the circuit board, and the insulating pad so as to completely close the opening, and the insulating pad having therein a through hole whereby the transmitting element is electrically connected to the circuit board.

6. The waterproof battery of claim 5, wherein the transmitting element is one of a flexible flat cable (FFC) and a flexible printed circuit (FPC).

7. The waterproof battery of claim 5, wherein the waterproof adhesive layer adheres to an opening-adjoining portion of the inner surface of the casing and a peripheral portion of the circuit board concurrently.

8. The waterproof battery of claim 5, wherein a recess portion is disposed on a sidewall of the opening of the casing for receiving the circuit board of the connecting unit.

9. The waterproof battery of claim 5, wherein the connector is a surface-mounted connector.
